(19) United States
(12) Patent Application Publication
(10) Pub. No.: US 2012/0013041 A1
(43) Pub. Date: Jan. 19, 2012

(54) METHOD OF FORMING SHELL OF ELECTRICAL DEVICE

(76) Inventors: Duanjian Cao, Shenzhen (CN); Junfeng Liu, Shenzhen (CN); Wenhai Luo, Shenzhen (CN)

(21) Appl. No.: 13/142,278

(22) PCT Filed: Dec. 24, 2009
(86) PCT No.: PCT/CN2009/075990

§ 371 Date: Sep. 26, 2011

(30) Foreign Application Priority Data
Dec. 26, 2008 (CN) 2008102416868

(51) Int. Cl. B29C 45/14

(52) U.S. Cl. 264/279

(57) ABSTRACT

A method of forming a shell of an electrical device comprises the steps of: conforming a sheet assembly to at least a part of an outer configuration of the shell, wherein the sheet assembly includes a sheet and a photo-cured coating on one side of the sheet, the coating forming a predetermined pattern; injecting a base material into an injection mold for forming the shell after placing the sheet assembly inside the injection mold, with the side of the sheet on which the photo-cured coating is formed facing a cavity of the injection mold; and removing the sheet assembly from the shell.

### CROSS REFERENCE TO RELATED APPLICATION

This application claims priority to Chinese Patent Application No. 200810241686.8, filed on Dec. 26, 2008, the entirety of which is hereby incorporated by reference.

### FIELD OF THE INVENTION

The present invention relates to injection molding, more particularly to a method of forming decorative configurations.

### BACKGROUND OF THE INVENTION

Currently, decoration of an electrical device is usually obtained by forming protruding textures or patterns on the device's surface. The textures on a surface of a plastic body are mainly formed by injection molding with a mold having the corresponding textures formed on the inner surfaces of the mold. Textures are formed on the inner surface of the mold by electroforming and etching. However, these two methods have the following shortcomings:

1. Nickel is commonly used for electroforming, so the hardness of the mold surface is too low, generally only about HRC 26 to 30, to bear high temperature and pressure during injection molding. As a result, the lifespan of the injection mold is relatively short, and it is not suitable for mass production;

2. During electroforming, it is difficult to ensure that the coating has a uniform thickness on the mold surface, especially on acute angled parts and the deeply concaved parts, which has a negative impact on the precision of the mold and on product quality; and

3. Etching is commonly carried out on a flat surface, which is difficult to achieve on a curved surface. Furthermore, the etching process may have a negative effect called side-etching phenomenon, and the precision of the etching process is difficult to control.

### SUMMARY OF THE INVENTION

The present invention is directed to solving at least one of the problems associated with the prior art. According to the present invention, a method of forming a shell for an electrical device is simple to operate and very easy to control with enhanced product quality and an improved appearance.

According to an embodiment of the present invention, a method of forming a shell of an electrical device comprises the steps of: A) providing a sheet with a photocured adhesive coating formed on a side thereof, the coating forming a predetermined pattern; B) conforming the sheet with the photo-cured coating to at least a part of an outer configuration of the shell; C) injecting a base material into an injection mold for forming the shell while placing the sheet inside the injection mold, with the side on which the photocured coating is formed facing toward a cavity of the injection mold; and D) removing the sheet from the shell.

According to an embodiment of the invention, the sheet may be conformed to at least a part of the outer configuration of the shell by thermal processing or punching.

According to an embodiment of the invention, the step A may further comprise the steps of: providing a mold plate with a pattern formed on the side thereof; coating photocuring adhesive at least on a portion of the mold plate where the pattern is formed; placing the sheet onto the mold plate to cover the portion coated with the photocuring adhesive; photocuring the adhesive; and removing the mold plate to obtain the sheet with the photocured coating formed on the side thereof.

According to an embodiment of the invention, the photo-cured coating is a layer with the predetermined pattern formed thereon.

According to an embodiment of the invention, the method may comprise a step of heating the shell before removing the sheet from the shell.

According to an embodiment of the invention, the sheet may be made from a material selected from a group consisting of polycarbonate, polyethylene terephthalate, polymethyl methacrylate, and acrylonitrile-butadiene-styrene copolymer.

According to an embodiment of the invention, the sheet may have a thickness of about 0.125 to 0.188 mm.

According to an embodiment of the invention, the sheet may have a melting temperature of about 50 to 80° C. higher than that of the base material.

According to the present invention, a predetermined pattern, such as a bossed texture, may be firstly formed on the sheet by coating a layer of photocuring adhesive. And then after curing and deforming to be conformed to the outer shape of the shell, plastic material may be injected onto the sheet at a side where the coating is formed so that the pattern is transferred onto the shell of the electrical device. Accordingly, the method is easy to operate with universal adaptability. And further, by curving the sheet, a protruding texture may be formed on a curved surface of the electrical device.

Other variations, embodiments and features of the present disclosure will become evident from the following detailed description, drawings and claims.

### BRIEF DESCRIPTION OF THE DRAWINGS

These and other aspects and advantages of the invention will become apparent and more readily appreciated from the following descriptions taken in conjunction with the drawings in which:

FIG. 1 shows a mold plate formed with a protruding pattern to be transferred to a shell of an electrical device according to an embodiment of the invention;

FIG. 2 shows a mold plate coated with photocuring adhesive according to an embodiment of the invention;

FIG. 3 shows a sheet covering the mold plate as shown in FIG. 2, in which a photocuring adhesive is coated into a groove;

FIG. 4 shows a sheet on which a pattern for forming a predetermined texture on the shell is formed according to an embodiment of the invention;

FIG. 5 shows a plan view of the sheet as shown in FIG. 4;

FIG. 6A shows a partial view in which the sheet with the pattern for forming texture on the shell is laid inside an injection mold according to an embodiment of the invention; and

FIG. 6B shows an enlarged view of part B indicated in FIG. 6A.

### DETAILED DESCRIPTION OF EMBODIMENTS OF THE INVENTION

It will be appreciated by those of ordinary skill in the art that the embodiments disclosed herein may be embodied in other specific forms without departing from the spirit or essential character thereof. The presently disclosed embodiments are therefore considered in all respects to be illustrative and not restrictive.

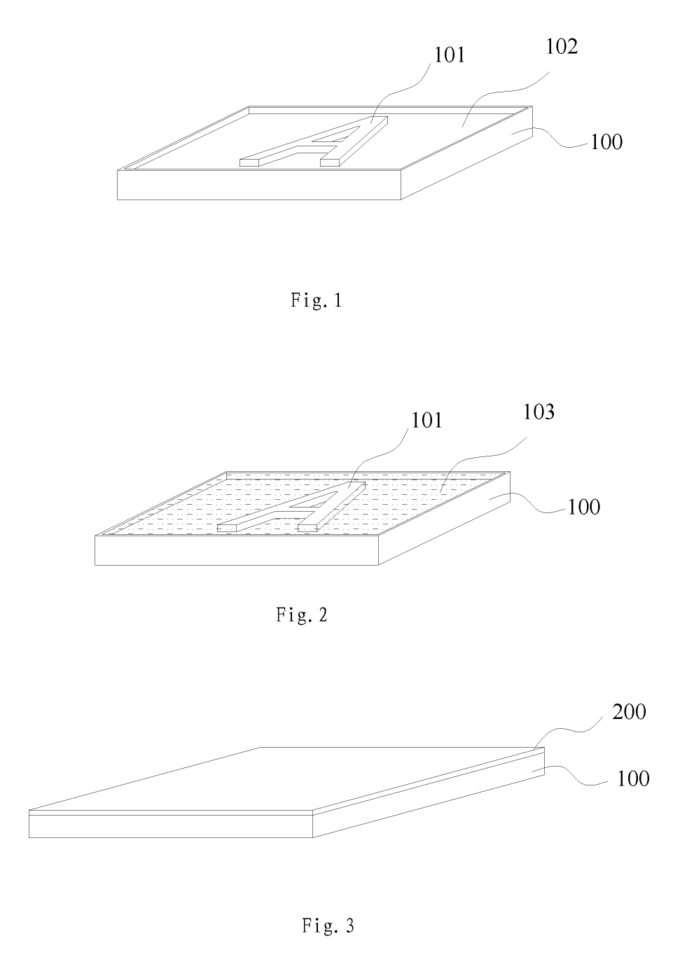

In the following, the present invention will be described in detail with reference to FIGS. 1-6.

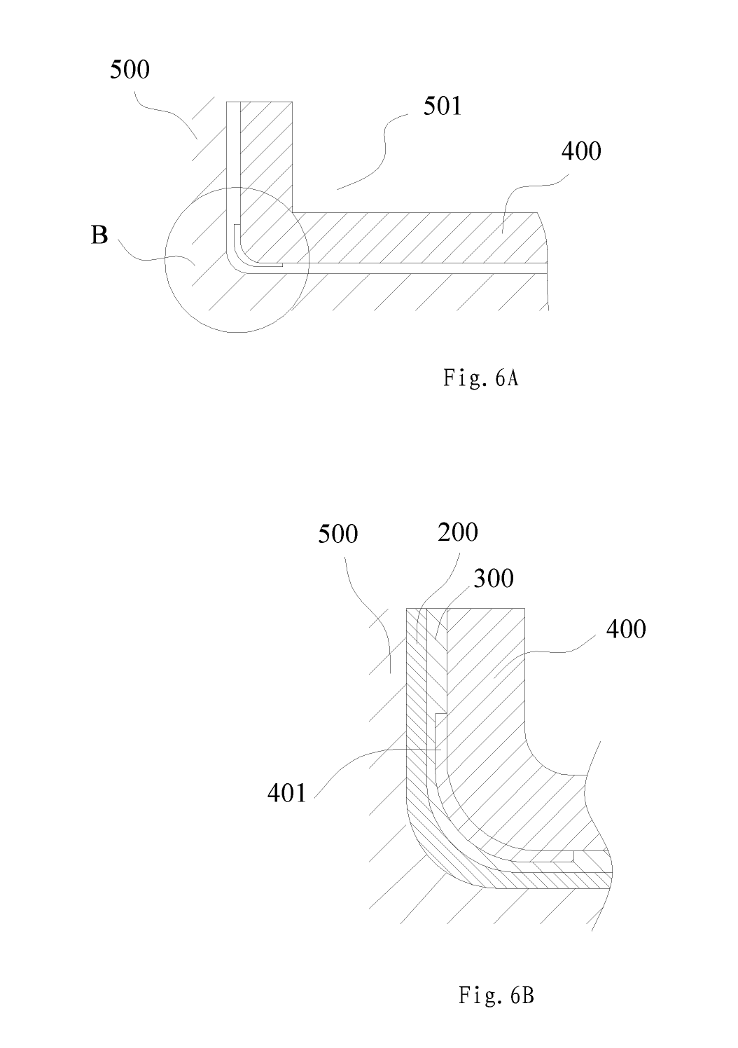

According to an embodiment of the present invention shown in FIGS. 6A and 6B, a method of forming a shell 400 of an electrical device (not shown) comprises the steps of:

A) providing a sheet 200 with a photocured adhesive coating 300 formed on a side thereof, the coating 300 forming a predetermined pattern which corresponds to the solid or three dimensional pattern to be formed on the shell 400 of the electrical device;

B) conforming the sheet 200 with the photo-cured coating 300 to at least a part of an outer configuration of the shell 400;

C) injecting a base material for the shell 400 into an injection mold 500 for forming the shell 400 with the sheet 200 inside the injection mold 500, as shown in FIG. 6A, and with the side on which the photo-cured coating 300 is formed facing toward a cavity 501 of the injection mold 500; and

D) removing the sheet 200 with the adhered coating 300 from the shell 400.

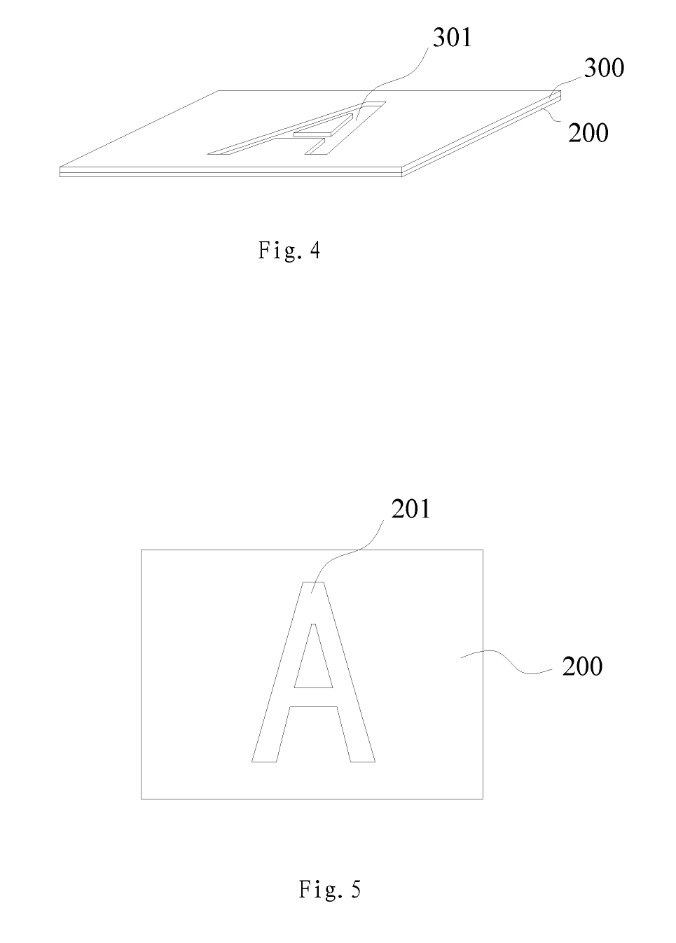

According to an embodiment of the invention, the coating 300 is formed into a layer predetermined pattern “A”, as shown in FIG. 4.

It should be noted that the shell 400 of the electrical device may be any one made by molding, such as a shell of a cell phone, Blackberry, iPhone, personal computer, etc. Thus, the embodiments described herein are for illustration only rather than for limitation.

The material of the sheet may be selected from a group consisting of polycarbonate (PC), polyethylene terephthalate (PET), polymethyl methacrylate (PMMA), and acrylonitrile-butadiene-styrene copolymer (ABS). And the thickness of the sheet may be about 0.125 to 0.188 mm. There is no special limitation on the material. Further, according to an embodiment of the invention, step A may further comprise the steps of: A1) providing a mold plate 100 with a convex pattern 101 formed on a side 102 of the mold plate 100, which pattern is consistent with that to be formed on the shell 400; A2) coating a photocuring adhesive 103 on at least a portion of the mold plate 100 where the pattern 101 is formed; A3) placing a sheet 200 onto the mold plate 100 to cover the portion coated with the photocuring adhesive 103; A4) photocuring the adhesive 103; and A5) removing the mold plate 100 to obtain the sheet 200 with the photocured coating 300 formed on the side thereof. According to an embodiment of the invention, the pattern may be a concave or convex one, or a specially designed one, such as a leather-simulating design of pattern with the adapted mold plate and coating process which may be easily understood by those skilled in the art after reading the present disclosure.

Further, it will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

The electrical device (not shown) may have decorating textures (including distributed protruding points) on its surface, which form the predetermined pattern 201 for decoration. In FIG. 1, the protruding pattern 101 forming letter “A” is shown for example.

To form the corresponding protruding letter “A” on a surface of the shell 400 (shown in FIG. 5A) for aesthetic purpose, the depth or thickness of the pattern 101 is preferably not be greater than 0.3 mm.

Then the photocuring adhesive 103 is coated onto at least the mold plate 100 as shown in FIG. 2. FIG. 2 shows the mold plate 100 coated with photocuring adhesive 103. The photocuring adhesive 103 may be any of those known in the art. And the photocuring adhesive 103 is liquid in normal state, and may be solidified after illuminating, such as UV illuminating. In one embodiment, a UV-curing adhesive may be used, such as 8086 UV adhesive distributed by Tongsheng Co., Ltd. Taiwan, China.

And the sheet 200 is placed on the mold plate 100 to cover the portion coated with the photocuring adhesive 103, as shown in FIG. 3. And the adhesive 103 is photocured into a predetermined pattern, as shown in FIG. 4. Then, the mold plate 100 is removed to obtain the sheet 200 with the photocured coating 300 formed at a side. FIG. 4 shows the sheet 200 on which the pattern 301 of a concave letter “A” is formed according to an embodiment of the invention. And FIG. 5 shows a plan view of the sheet 200 shown in FIG. 4.

In some embodiments, the injection molding 500 may have the molding cavity 501, and the sheet 200 and the coating 300 are conformed to at least a part of the inner surface of the molding cavity 501. The sheet 200 can mate with one surface of the molding cavity or the sheet may be configured or shaped to mate with more than one surface of the molding cavity 501, for example, two, three, four or five surfaces of the molding cavity 501. The mated position and mated area may be determined according to requirements of the electrical device. For example, if the electrical device is the shell 400 with side surfaces and only its bottom surface and only one of the side surfaces need to be decorated with solid pattern, the sheet 200 may be mated with the inner surfaces of the molding cavity 501 corresponding to these two surfaces.

In some embodiments, the method for forming the shell 400 of the electrical device may further comprise a step of punching or stamping the sheet to mate with the shape of the molding cavity 501. The sheet 200 may be thermally pressed to conform to the shape of the electrical device using the molding cavity, so that the sheet and the electrical device may have corresponding shape in which they are mated with each other. During a thermal pressing process, the mold temperature may be about 100 to 130° C., the pressure may be about 18 to 23 kgf/cm² and the thermal pressing process may last for about 30 to 40 seconds. The residual parts of the sheet may be cut off after thermal pressing.

For convenience of separation, the sheet has a melting temperature about 50 to 80° C. higher than that of the melting temperature of the base material. According to an embodiment of the invention, if the material of the sheet is PC, the base material may be ABS. The materials for forming the sheet 200 and the layer of coating 300 are different from that of shell 400 so that the sheet 200 and the layer of coating 300 can be separated easily from the shell 400 made from the base material after molding.

The electrical device may be heated before the sheet is removed. In some embodiments, the electrical device may be soaked in water at a temperature of about 80 to 90° C. for about 2 to 10 minutes so that the sheet 200 may be easily separated from the shell 400 of the electrical device shown in FIG. 6A.

The method of molding the base material onto the surface of the sheet 200 may be any injection molding method known in the prior art.

### Example

In the following, a cell phone, as an example of the electrical device according to an embodiment of the invention, is used in a further description of the process according to the present invention. The shell may have a predetermined pattern, such as a protruding texture, on its surface, and the protruding texture is formed by UV-curing adhesive.

During the process, the method of the invention may adopt the following parameters:

(1) Convex pattern 101, 75 mm×150 mm in size and about 0.2 mm in thickness, is formed on the mold plate 100 with a size of 200 mm×150 mm×10 mm.

(2) A UV-curing adhesive is coated into the pattern 101. The amount of UV-curing adhesive is used to fill at least the pattern 101 and the neighboring areas. According to an embodiment of the invention,

(3) A PC sheet 200 with a thickness of 0.188 mm is placed onto the UV-curing adhesive 103. The PC sheet 200 is then pressed by a roller (not shown) to make the UV-curing adhesive covering all the texture areas. Bubbles should be avoided during pressing.

(4) The PC sheet 200 with the mold plate 100 is placed into a UV-curing machine (not shown) for curing by UV illumination. The process is controlled according to the condition known in the art to ensure that the UV-curing adhesive is totally solidified without changing to yellow and without deformation.

(5) The PC sheet 200 with the UV-curing coating is removed off from the mold plate 100 carefully to avoid the UV-cured coating from being damaged. According to an embodiment of the invention, the PC sheet 200 with the UV-cured coating may be removed manually.

(6) The PC sheet 200 with the predetermined pattern formed is placed into the mold 500 of the shell 400 of the cell phone, with the UV-cured coating facing the molding cavity 501, as shown in FIG. 6A. Then the PC sheet 200 is thermally pressed to be conformed to the shape of the shell of the cell phone at the temperature of 120° C. under the pressure of 20 kgf/cm² for 40 seconds. The unwanted parts of the sheet are cut off after thermal pressing with a cutting pressure of 40 kgf/cm².

(7) The PC sheet 200 is placed into the injection molding mold 500 with the surface of having no layer of UV-cured coating 300 being attached to the inner surface of the mold 500. And then ABS material is injected onto the sheet 200 to obtain the shell 400 of the cell phone (not shown). FIG. 6B shows an enlarged view of part B indicated in FIG. 6A. As shown in FIG. 6B, the sheet with the layer of coating 300 is positioned at a curved part in the mold 500 to form desired patterns on the shell 400. And when the sheet 200 with the layer of coating 300 is taken out of the mold, an aesthetic spatial pattern may be formed on the curved part of the shell 400.

(8) After the shell 400 of the cell phone with the sheet 200 and the layer of coating 300 is removed from the mold 500, they are placed into warm water with a temperature of 80° C. for 10 minutes.

(9) Then, the sheet 200 and the layer of coating 300 are removed from the shell 400 of the cell phone manually to obtain the shell 400 of the cell phone with the desired predetermined pattern being formed on its outer surface. In one embodiment of the invention, the pattern 201 of the solid letter “A” is formed protruding from the surface of the shell 400 of the cell phone, as shown in FIG. 6B. After separating the sheet 200 with the layer of coating 300 from the shell 400, the pattern formed on the shell 400 leaves a solid or three-dimensional attraction for a normal user.

Although the present disclosure has been described in detail with reference to several embodiments, additional variations and modifications exist within the scope and spirit as described and defined in the following claims.

1. A method of forming a shell of an electrical device, comprising the steps of:
A) conforming a sheet assembly to at least a part of an outer configuration of the shell; wherein the sheet assembly includes a sheet and a photo-cured coating on one side of the sheet, the coating forming a predetermined pattern; and
B) injecting a base material into an injection mold for forming the shell after placing the sheet assembly inside the injection mold, with the side of the sheet on which the photo-cured coating is formed facing toward a cavity of the injection mold.

2. The method according to claim 1, wherein the photo-cured coating is a layer having the predetermined pattern.

3. The method according to claim 1, wherein the photo-cured coating has a solid or three dimensional predetermined pattern.

4. The method according to claim 3, wherein the sheet is elastic so that the sheet assembly is deformed during step B.

5. The method according to claim 1, wherein the sheet assembly is conformed to at least a part of the outer configuration of the shell by thermal processing or punching.

6. The method according to claim 1, further comprising the step of forming the sheet assembly, wherein the step of forming the sheet assembly includes:
coating a photocuring adhesive on at least a portion of a mold plate, wherein the portion of the mold plate has the predetermined pattern;
placing the sheet onto the mold plate to cover the portion coated with the photocuring adhesive;
photocuring the adhesive; and
removing the mold plate to obtain the sheet assembly.

7. The method according to claim 6, wherein the pattern has a maximal thickness of 0.3 mm.

8. The method according to claim 15, further comprising the step of:
D) heating the shell before removing the sheet assembly from the shell.

9. The method according to claim 8, wherein in the step D the shell is soaked in water with a temperature of about 80 to 90° C.

10. The method according to claim 9, wherein the shell is soaked in the water for about 2 to 10 minutes.

11. The method according to claim 1, wherein the sheet is made from a material selected from a group consisting of polycarbonate, polyethylene terephthalate, polymethyl methacrylate, and acrylonitrile-butadiene-styrene copolymer.

12. The method according to claim 11, wherein materials for forming the sheet assembly are different from that of the shell.

13. The method according to claim 1, wherein the sheet has a thickness of about 0.125 to 0.188 mm.

14. The method according to claim 1, wherein the sheet assembly has a melting temperature about 50 to 80° C. higher than that of the base material.

15. The method according to claim 1, further comprising the step of:
C) removing the sheet assembly from the shell.
